(19) United States
(12) Patent Application Publication
(10) Pub. No.: US 2025/0378471 A1
(43) Pub. Date: Dec. 11, 2025

(54) PRODUCT AND SERVICE REVIEWS BASED ON CONTACT INFORMATION

(71) Applicant: MOTOROLA MOBILITY LLC, WILMINGTON, DE (US)

(72) Inventors: AMIT KUMAR AGRAWAL, BANGALORE (IN); VIJAYPRAKASH IDLUR, IDLUR (IN); SOMINA LAKSHMANA HANUMAN MAHATH, BENGALURU (IN)

(21) Appl. No.: 18/737,722

(22) Filed: Jun. 7, 2024

(51) Int. Cl. G06Q 30/0282; G06Q 30/0601

(52) U.S. Cl. CPC G06Q 30/0282; G06Q 30/0631; G06Q 30/0641

(57) ABSTRACT

A method provides techniques for item query initiation based on contact information. Prepurchase activity for an item, such as a product or service, is detected. A list of one or more reviews for the item is obtained. For each review in the list, a user identifier is obtained. A determination is made, based on the user identifier, if one or more reviews in the list of reviews correspond to a contact in a contact list associated with the electronic device. In response to determining that a user identifier associated with at least one review corresponds to a contact in the contact list, a query pertaining to the item for presentation to the contact is generated. The query is sent to the contact. A reply from the contact may be received and analyzed to generate a purchase recommendation.

### BACKGROUND

### 1. Technical Field

The present disclosure generally relates to electronic devices, and more specifically to electronic devices that can be used for online researching and purchasing of products.

### 2. Description of the Related Art

Online shopping via electronic devices offers a convenient way for a consumer to shop anytime, anywhere, without the need to visit physical stores. Shopping online offers several advantages over shopping at a brick-and-mortar store. One of the main advantages is the convenience of shopping from anywhere, at any time, without the need to travel to a physical store. Furthermore, online shopping provides access to a wider range of products and brands that may not be available locally. Online shopping allows for easy comparison of prices across different retailers, helping consumers find the best deals. Moreover, online shopping offers various delivery options, including home delivery, express shipping, and in-store pickup, providing flexibility to consumers. Furthermore, most online shopping sites are always available, allowing consumers to shop at their convenience, even outside of regular store hours. Additionally, ecommerce has driven the adoption of digital payment methods, making transactions faster and more secure.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement an item query initiation (IQI) feature, according to one or more embodiments;

FIG. 2 depicts an exemplary user interface indicating online reviews of products/services associated with user contacts, according to one or more embodiments;

FIG. 3 illustrates an exemplary user interface for an automated item query, according to one or more embodiments;

FIG. 4 illustrates another exemplary user interface for an automated item query, according to one or more embodiments;

FIG. 5 illustrates a user interface for displaying exemplary recommendation responses from an autonomously generated query, according to one or more embodiments;

FIG. 6 illustrates an exemplary user interface for an automated item recommendation, according to one or more embodiments;

FIG. 7 depicts an exemplary review ranking user interface, according to one or more embodiments;

FIG. 8 depicts a flowchart of a method for item query initiation, according to one or more embodiments;

FIG. 9 depicts a flowchart of a method for salutation generation, according to one or more embodiments; and

FIG. 10 depicts a flowchart of a method for sorting reviews based on trust level, according to one or more embodiments.

### DETAILED DESCRIPTION

According to aspects of the present disclosure, an electronic device, a method, and a computer program product provide techniques for implementing a query regarding a product or service that a user is contemplating purchasing, or otherwise acquiring, based on contact information. Prepurchase activity on an ecommerce (i.e., online purchasing) site is detected for an item, such as a product or service. The prepurchase activity can include browsing an online shopping website, adding items, such as products and/or services, to an online shopping cart, watch list, favorites list, and/or ‘save for later’ list. A list of one or more reviews for the item is obtained. For each review in the list, a user identifier is obtained. A determination is made, based on the user identifier, if one or more reviews in the list of reviews correspond to a contact in a contact list associated with the electronic device. In response to determining that a user identifier associated with at least one review corresponds to a contact in the contact list, a query pertaining to the item is generated for presentation to the contact. In one or more embodiments, the generated query is based on a communication pattern. As an example, for a contact that is frequently communicated with, a first type of informal query can be generated, while for a contact that is occasionally communicated with, a second type of query can be generated. The query is transmitted to the contact. A reply received from the contact is analyzed and may be utilized in generating a purchase recommendation for the item. The purchase recommendation is presented on the display of the user device.

Product reviews play a crucial role for many consumers in making a purchase decision. Reviews provide firsthand information from other customers and can be more trustworthy than marketing messages from the seller. Reviews often include detailed information about the quality, performance, and features of the item being considered (e.g., a product and/or service available for purchase from the seller), helping potential buyers understand what to expect if they proceed with the purchase of the item. Positive reviews can serve as social reassurance to potential buyers that they are making a good decision. However, the aforementioned benefits apply when the reviews are legitimate and not fake reviews generated by computers or people who receive some enticement or pecuniary benefit to provide positive reviews that are not a result of their personal experiences with the item. The presence of fake reviews can degrade the effectiveness of the consumer relying on the presented item reviews. Fake reviews can significantly impact the credibility and usefulness of product/service reviews. Fake reviews can mislead consumers by providing inaccurate or exaggerated information about a product/service. Furthermore, fake reviews can erode trust in the review system, making consumers skeptical of all reviews, even genuine reviews. Moreover, consumers who rely on fake reviews may end up purchasing products/services that do not meet their expectations, resulting in wasted time and money.

The disclosed embodiments alleviate the aforementioned issues caused by the presence of fake reviews by identifying product reviews that are associated with contacts of a user considering purchasing the item. Recommendations from friends, family, or colleagues are often more trusted than traditional advertising, as they come from a personal perspective. Thus, reviews that originate from known contacts may have a higher degree of credibility for a user than reviews from unknown sources. In addition to identifying reviews from contacts, one or more embodiments simplify the task of communicating with the contacts for following up on the satisfaction of the contact with a given item. Often, a purchaser of an item such as a product and/or service reviews the item shortly after purchase. Over time, the item may meet the expectations of the purchaser, exceed the expectations of the purchaser, or fall short of the expectations of the purchaser. Disclosed embodiments assist in capturing this valuable post-purchase feedback from contacts known to the user and who reviewed, own, or have used the product/service. Accordingly, disclosed embodiments enable a user to make informed decisions regarding the purchases of products/services by obtaining what can be the most credible review information available to them, which is the thoughts and opinions of known contacts.

According to one or more embodiments, reviews that originate from known users (i.e., identified within the contacts list) are identified. The identification can be based on metadata such as a user name, geographical location, and/or other suitable metadata. Additionally, in one or more embodiments, a query is automatically generated about the item (product, service, etc.) for sending to the contact. The query is generated to illicit additional or updated review data from the contact about the item. The query can be generated based on a variety of factors, including a communication pattern between the user and the contact. As an example, frequent and/or recent communication may be used to generate a first type of query. With this example, infrequent and/or non-recent communication may be used to generate a second type of query.

According to one or more embodiments, the list of reviews for a given item are sorted based on being associated with a known contact. The sorting can give priority to reviews associated with a known contact, such that those reviews appear first in a list of reviews and/or are highlighted or otherwise indicated as originating from a known contact. In one or more embodiments, a trust score is generated for the review. The trust score can be based on the source of the review, the role of the contact associated with the review, and/or a communication pattern with the contact associated with the review. These features can provide the benefits of identifying trustworthy item reviews, as well as automating the process of soliciting additional feedback on the item from known contacts. These, and other advantages of disclosed embodiments are further explained in the following detailed description.

One or more embodiments can include an electronic device including: at least one output device, including a display; a communication system that enables the electronic device to communicatively connect with an online purchasing portal and at least one second electronic device of a known contact; a memory having stored thereon an item query initiation (IQI) module; and at least one processor communicatively coupled to the display, the communication system, and the memory. The at least one processor executes program code of the IQI module and configures the electronic device to: detect prepurchase activity for an item; obtain a list of one or more reviews for the item; parse the reviews to obtain a user identifier for each review in the list of one or more reviews; determine, based on the user identifier, if one or more reviews in the list of reviews correspond to a contact in a contact list associated with the electronic device; and in response to determining that a user identifier associated with at least one review corresponds to a contact in the contact list: sort the list of reviews based at least in part on user identifiers associated with reviews in the list of reviews that correspond to contacts in the contact list; and presenting the sorted list of reviews on the display.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

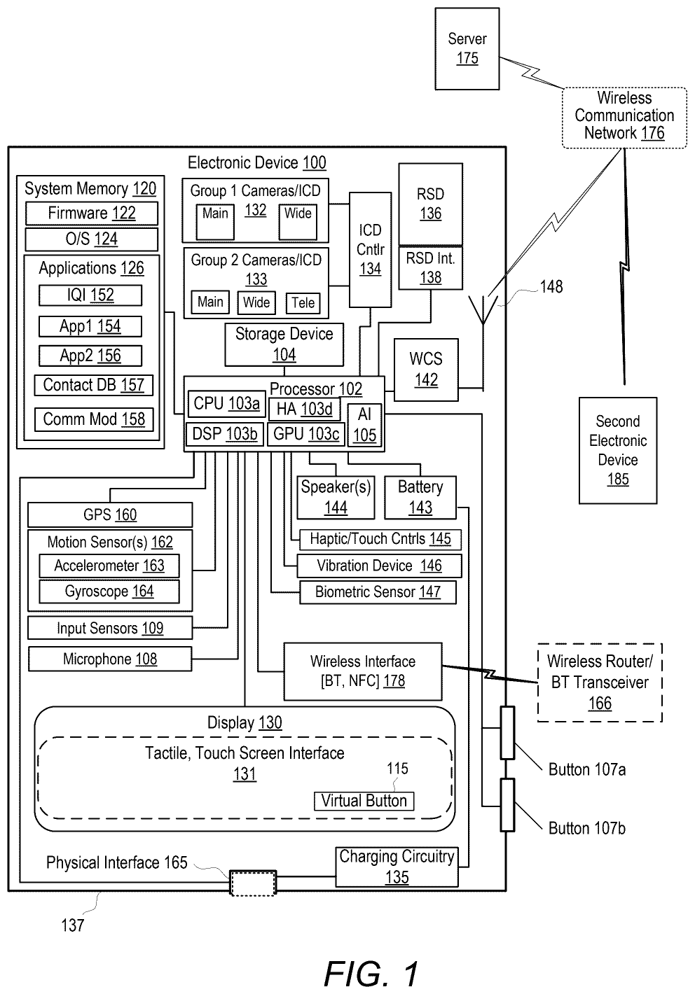

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide item query initiation functions, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control front-facing and rear-facing cameras 132, 133 to capture video or still images of a local scene within a FOV of the operating/active one of cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, item query initiation (IQI) module 152, other applications, indicated as App1 154, App2 156, contact database 157, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, IQI module 152 can include program instructions for implementing features of disclosed embodiments. The features can include identifying an item (product or service) for which a user is performing prepurchase activity, finding online reviews for the item, determining if any of the online reviews originate from contacts associated with the user, and provide an automated query for contacts that have provided reviews, where the automated query solicits current feedback from the contact regarding the item. Moreover, contact database 157 can store metadata pertaining to known contacts. The metadata can include, but is not limited to, a name of the contact, one or more user identifiers pertaining to the contact, one or more aliases (nicknames) pertaining to the contact, telephone number(s) for the contact, email address(es) for the contact, a relationship for the contact (friend, coworker, spouse, sibling, etc.), a mailing address for the contact, and so on. In one or more embodiments, the contact database 157 may further include a communication log for each contact. The communication log may include dates, times, and/or durations of communications between electronic device 100 and a second electronic device corresponding to the contact. In one or more embodiments, data within contact database 157 is used for performing functions of identifying reviews as being associated with known contacts. In one or more embodiments, instead of, or in addition to, being stored on the device 100, the contact database can be stored external to device 100, such as on server 175, and/or other remote devices.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices. Biometric sensor 147 can be used to read/receive biometric data, such as fingerprints, to identify or authenticate a user. In some embodiments, the biometric sensor 147 can supplement an ICD (camera) for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can also be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175 and other communication devices, which can be similarly connected to wireless communication network 176. In one or more embodiments, various functions that are being performed on communications device 100 can be supported using or completed via/on server 175. In one or more embodiments, the server 175 can provide ecommerce functions, such as online shopping, as well as storing reviews for items offered for purchase or customer acquisition on ecommerce websites.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communication interface(s) of electronic device 100.

Second electronic device 185 may correspond to a known contact stored within electronic device 100 and be communicatively accessible via a unique device ID, such as a phone number. As an example, second electronic device 185 may be associated with a friend or relative of the user of electronic device 100. Accordingly, in one or more embodiments, electronic device 100 may transmit a query to second electronic device 185. Additionally, in one or more embodiments, electronic device 100 may receive a recommendation response from second electronic device 185.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

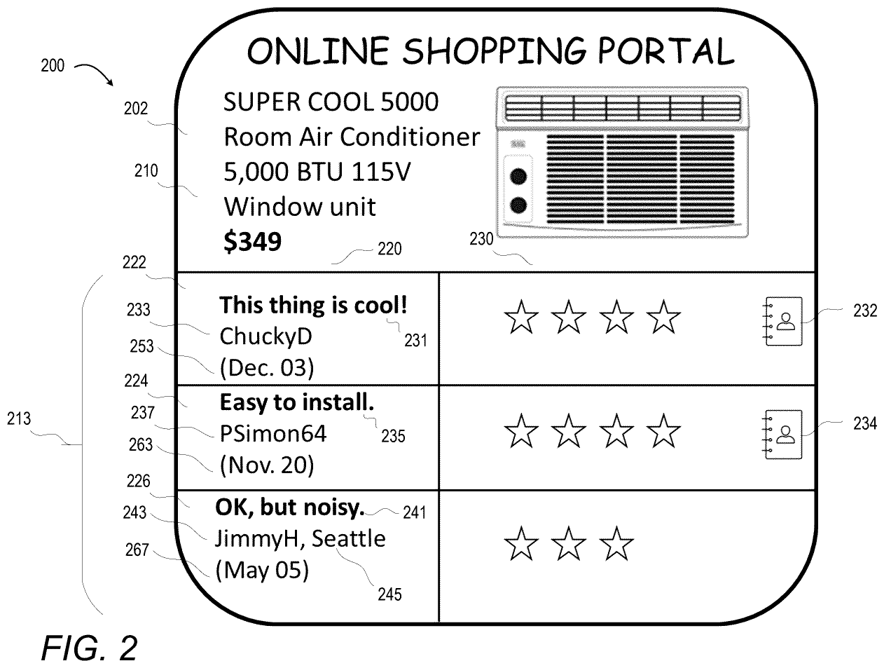

FIG. 2 depicts an exemplary online shopping user interface 200 presenting a product and reviews of the product that are associated with user contacts, according to one or more embodiments. In one or more embodiments, the user interface shown in FIG. 2 may be rendered on a display 202 of a device such as device 100 of FIG. 1. The user interface 200 includes an item summary section 210. The item summary section 210 includes information about an item, which for illustrative purposes is a room air conditioner. The information can include, but is not limited to, a name of the item, a model number for the item, one or more images of the item, video clips of the item, pricing for the item, and/or other specifications pertaining to the item. The user interface 200 includes a review section 213. The review section 213 includes column 220, which includes text pertaining to reviews, and column 230, which includes ratings for reviews. As shown in FIG. 2, there are three rows in the review section 213, indicated as row 222, row 224, and row 226. In embodiments, there can be more or fewer rows than shown in FIG. 2. Referring to row 222, column 220, there is shown review text 231, a corresponding user identifier 233 and review date 253. In row 222, column 230 there is shown a rating of four stars. While the user interface 200 depicts ratings using graphical icons such as stars, other embodiments may include a numeric rating, an enumerated list of words (good, fair, poor, etc.), and/or a combination of numeric ratings, enumerated lists, and/or graphical icons. Similarly, in row 224, column 220, there is shown a second review, with review text 235, a user identifier 237, and review date 263. In row 224, column 230, there is shown a rating of four stars. Similarly, in row 226, column 220, there is shown a third review, with review text 241, a user identifier 243, and review date 267. Optionally, in one or more embodiments, additional metadata, such as a geographical location 245 may be shown. Other metadata can include, but is not limited to, a date of the review, a number of reviews the reviewer has submitted, an average rating the reviewer gives, and so on. In row 226, column 230, there is shown a rating of three stars. In user interface 200, reviews that correspond to known contacts may be indicated with a graphical indicator such as shown at 232 and 234. Thus, in FIG. 2, the review at row 222 and the review at row 224 correspond to known contacts, such as contacts stored in contact database 157 of FIG. 1. Conversely, the review at row 226 does not have a corresponding graphical indicator, and thus, does not correspond to a known contact.

In one or more embodiments, the correlating of a review with a known contact can include obtaining a user identifier associated with the review, and finding a corresponding user identifier in a contact database that includes known contacts. In one or more embodiments, an exact match between a user identifier from a review and a user identifier in a contact record within the contact database is used for correlating of a review with a known contact. In one or more embodiments, a fuzzy match between a user identifier from a review and a user identifier in a contact record within the contact database is used for correlating of a review with a known contact. In one or more embodiments, the fuzzy match process includes comparing two strings and calculating a similarity score based on how similar the strings are. In one or more embodiments, the fuzzy match process includes computing a Levenshtein distance, Jaro-Winkler distance, and/or other suitable metrics for similarity determination. One or more embodiments may further include use of metadata, such a geographical location, nicknames and/or aliases, and/or other associated metadata as part of the determination of if a review came from a known contact.

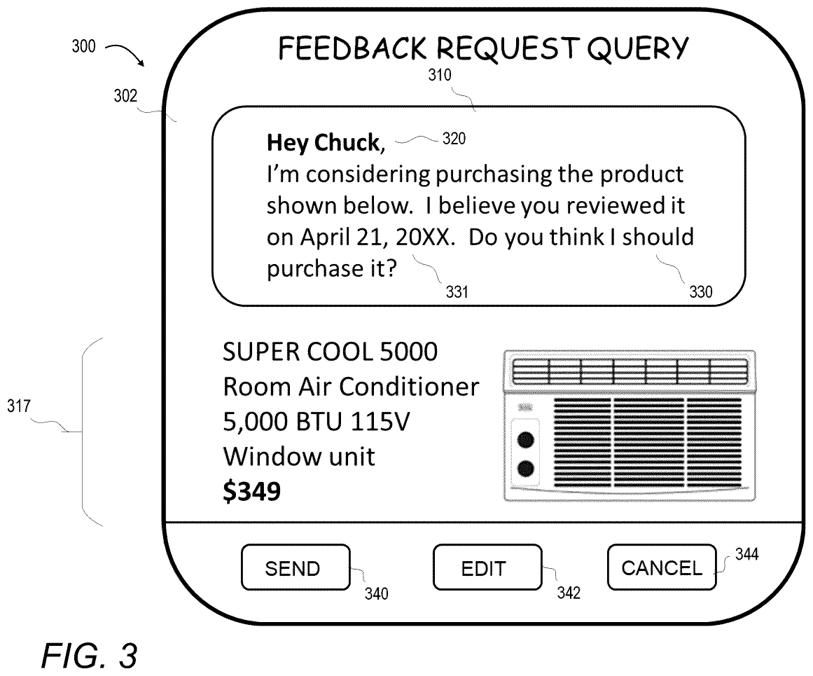

FIG. 3 illustrates an exemplary user interface 300 for an automated item feedback request query (FRQ), according to one or more embodiments. In one or more embodiments, the user interface shown in FIG. 3 may be automatically generated and rendered on a display 302 of a device such as device 100 of FIG. 1. The user interface 300 includes an item FRQ 310, which is a request for feedback from a selected contact about the item being considered for purchase. In one or more embodiments, the item FRQ 310 may be generated via machine learning models that utilize natural language processing (NLP) techniques. In one or more embodiments, a template-based portion 330 is used for the response. Certain fields, such as a date of review 331 may be populated at query generation time. The query may further include a salutation 320. In one or more embodiments, the salutation is based on a communication pattern. In one or more embodiments, the communication pattern is obtained from a communication log stored on the device. In one or more embodiments, the frequency and/or recentness of communication with the particular contact may be used for determining a type of salutation. For example, for a contact who is a friend named ‘Chuck’ who is communicated with often, an informal salutation such as ‘Hey Chuck’ may be appropriate. In contrast, for a contact that has not been communicated with in many months, a more appropriate salutation may include an introductory phrase such as ‘Hello, I hope you are well’ or some other similar introductory salutation. Without such a phrase, the communication to someone that has not been communicated with in a long time can seem socially awkward. The salutation can include a level of formality. The level of formality can include formal, polite, causal, and so on. In one or more embodiments, a role (relationship) of the contact to the user may be used for determining a type of salutation. As an example, a salutation for a business associate may differ from a salutation used for a personal friend. Thus, the salutation for a business associate may be more formal than a salutation used to address a personal friend. In one or more embodiments, the query and/or salutation, may be generated by one or more AI engines 105 of FIG. 1.

The user interface 300 can further include an item summary section 317. The item summary section 317 includes information about an item for which the FRQ was generated. The information can include, but is not limited to, a name of the item, a model number for the item, one or more images of the item, video clips of the item, the vendor/merchant/seller/supplier of the item, pricing for the item, and/or other specifications pertaining to the item. The user interface may further include a send button 340. The send button 340, when invoked (e.g., via tap, click, etc.) causes a processor of the electronic device to transmit, via the communication system, the query to a second electronic device. In one or more embodiments, in response to the send button 340 being invoked, the item FRQ 310, along with the item summary section 317, may be automatically sent to by the electronic device to the second electronic device corresponding to the contact. The user interface may further include an edit button 342. The edit button 342, when invoked (e.g., via tap, click, etc.) causes a processor of the electronic device to enable editing by the user of the salutation 320 and/or template-based portion 330 prior to sending. The user interface 300 may further include a cancel button 344. The cancel button 344, when invoked (e.g., via tap, click, etc.) causes a processor of the electronic device to cancel (discard) the query. In one or more embodiments, a plurality of these item FRQs can be generated, one for each item reviewer that is a known contact to the user. One or more embodiments can include generating a query pertaining to the item for presentation to the contact.

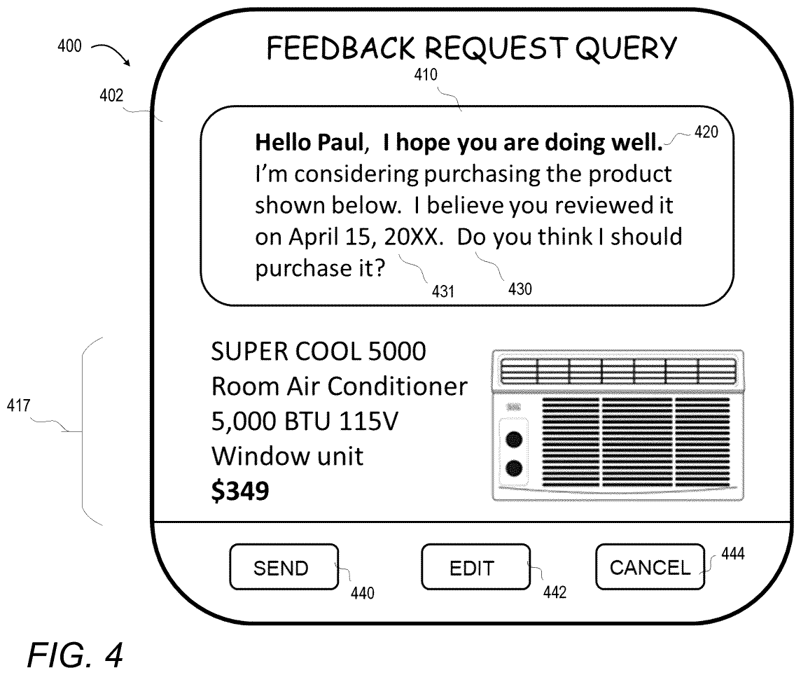

FIG. 4 illustrates another exemplary user interface 400 for an automated item query, according to one or more embodiments. In one or more embodiments, the user interface shown in FIG. 4 may be rendered on a display 402 of a device such as device 100 of FIG. 1. The user interface 400 includes an item FRQ 410 pertaining to the item for presentation to the contact. In one or more embodiments, the item FRQ 410 may be generated via machine learning models that utilize natural language processing (NLP) techniques. In one or more embodiments, a template-based portion 430 is used for the response. Similar to the example shown in FIG. 3, certain fields, such as a date of review 431 may be populated at query generation time. The query may further include a salutation 420. The salutation 420 is of a formal/polite type, well-suited for sending to a contact that is has a formal relationship with the user, such as a boss, business colleague, or client. The salutation 420 is also well suited for sending to a contact whom the user has not been communicated with for a duration that exceeds a predetermined threshold. In one or more embodiments, the predetermined threshold to trigger a formal/polite salutation can be six months. Other predetermined threshold values, in terms of time since a last contact, are possible in one or more embodiments. In contrast, the salutation 320 of FIG. 3 is of a causal/informal type that is well-suited for a contact that has had frequent and/or recent communication with the device 100 of FIG. 1. It is appreciated that where the FRQ communication is being sent as an SMS message for surfacing as a notification or text message on the contact's device, the level of formality may be less than where the FRQ communication is being transmitted as an email to an email address of the contact.

The user interface 400 can further include an item summary section 417, send button 440, edit button 442, and cancel button 444, which are similar to those described for FIG. 3. Accordingly, embodiments provide the convenience of quickly sending a query to a contact, while still enabling the flexibility of editing/customizing the query prior to sending it. The embodiments can include customizing a salutation preference. In one or more embodiments, the salutation preferences can include causal, formal, including the name of the contact, and/or other associated options.

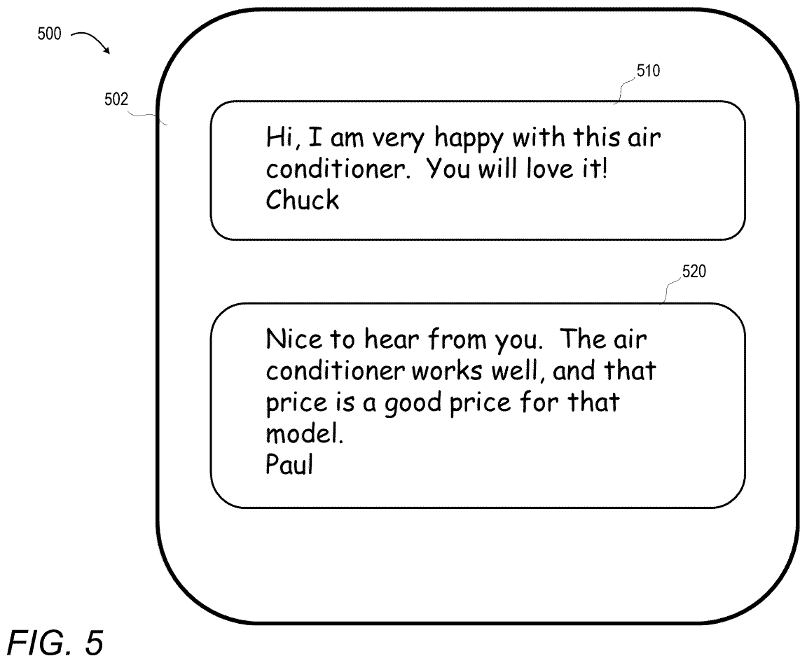

FIG. 5 illustrates a user interface 500 for displaying exemplary recommendation responses, according to one or more embodiments. In one or more embodiments, the user interface shown in FIG. 5 may be rendered by a processor on a display 502 of a device such as device 100 of FIG. 1. The user interface 500 includes one or more received recommendation responses from users that were previously sent an item FRQ such as shown in FIG. 3 and/or FIG. 4. Continuing with the examples shown in FIG. 3 and FIG. 4, first recommendation response 510 is received in response to item FRQ 310 of FIG. 3, and second recommendation response 520 is received in response to item FRQ 410 of FIG. 4.

In one or more embodiments, AI analysis is performed on each received recommendation response. The AI analysis can include natural language processing (NLP) performed by machine learning, such as by one or more AI engines 105 of FIG. 1. In one or more embodiments, the computerized analysis can include sentiment analysis. In one or more embodiments, the sentiment analysis can include text preprocessing. The text preprocessing can include removal of special characters, punctuation, and stopwords (common words like “and,” “the,” etc.). The remaining text can be subject to a tokenization process, in which the remaining text is broken down into tokens. In one or more embodiments, the tokens can be words, phrases, or sentences. The sentiment analysis can further include a feature extraction process, in which one or more features are extracted from the text, which could include word frequency, n-grams (contiguous sequences of n items from a given sample of text), or other linguistic features. AI models executing on AI engine 105 of FIG. 1 can be used to classify the sentiment of the text. The classification can be lexicon-based and/or based on trained models that utilize one or more neural networks. In one or more embodiments, the neural networks can include one or more of Support Vector Machines (SVM), Bayesian Filters, Recurrent Neural Networks (RNNs), and/or Transformer-based neural networks. In one or more embodiments, the result of the sentiment analysis of each of the one or more received recommendation responses can be used in generation of a purchase recommendation for the item. In one or more embodiments, multiple received recommendation responses can be analyzed. An overall sentiment based on an average sentiment from all the reviews can be computed, and used as a criterion for generating a purchase recommendation. One or more embodiments can include: receiving at least one recommendation response from at least one second electronic device; and generating a purchase recommendation for the item, based on the received at least one recommendation response. In one or more embodiments, the overall sentiment can indicate a recommendation to purchase the item, a recommendation to not purchase the item, a recommendation to use a specific vendor, a recommendation not to use a specific vendor, a recommendation to select a different item for purchase, and so on.

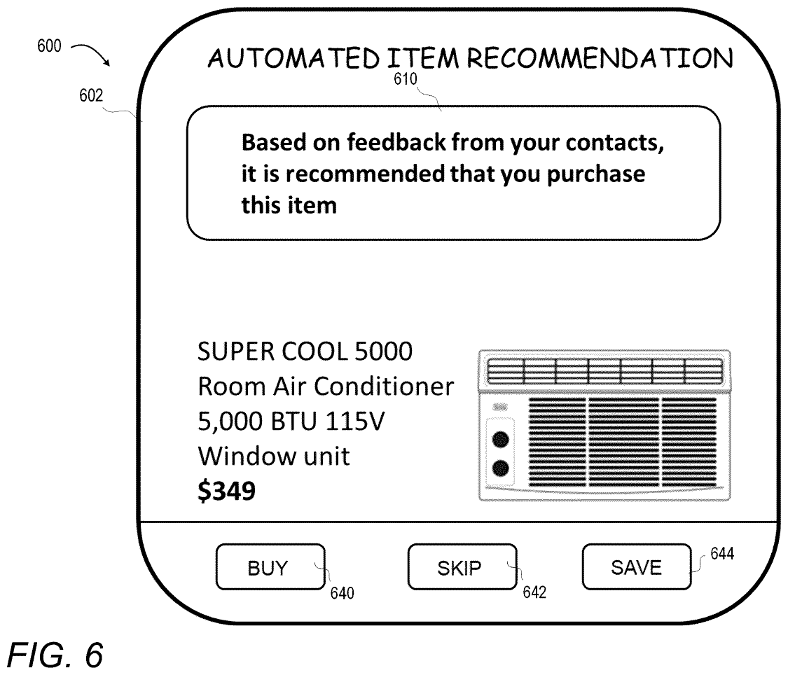

FIG. 6 illustrates an exemplary user interface 600 for an automated item recommendation, according to one or more embodiments. In one or more embodiments, the user interface shown in FIG. 6 may be rendered on a display 602 of a device such as device 100 of FIG. 1. The user interface 600 includes an automated item recommendation 610. In one or more embodiments, the automated item recommendation 610 may be based on feedback from contacts to the item FRQs. Examples of item FRQs are shown in FIG. 3 and FIG. 4, and examples of feedback, in the form of recommendation responses, are shown in FIG. 5.

The user interface may further include a buy button 640. The buy button 640, when invoked (e.g., via tap, click, etc.) causes a processor of the electronic device to transmit, via the communication system, a purchase request to an online shopping system, such as hosted by server 175 of FIG. 1. The user interface may further include a skip button 642. The skip button 642, when invoked (e.g., via tap, click, etc.) causes a processor of the electronic device to cancel (discard) the item recommendation. The user interface may further include a save button 644. The save button 644, when invoked (e.g., via tap, click, etc.) causes a processor of the electronic device to save the automated item recommendation 610 to memory on the electronic device and/or cloud-based storage, for further review at a later time. Accordingly, disclosed embodiments improve the technical field of managing electronic records, such as electronic records pertaining to product reviews.

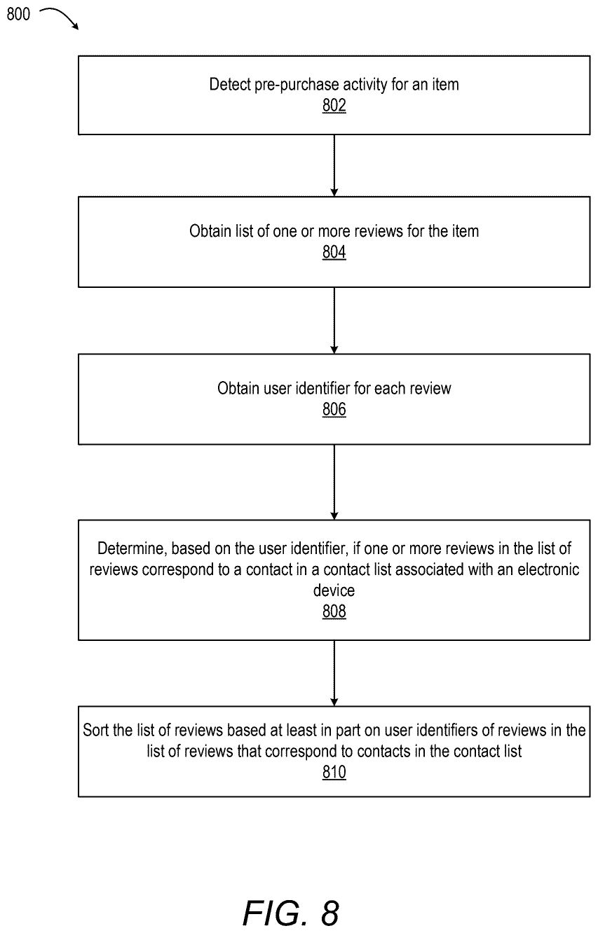

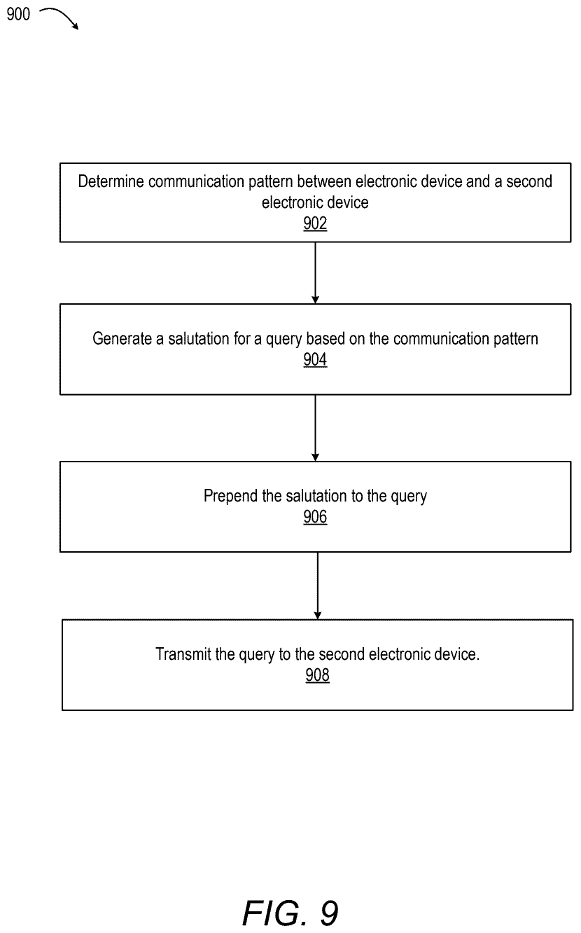

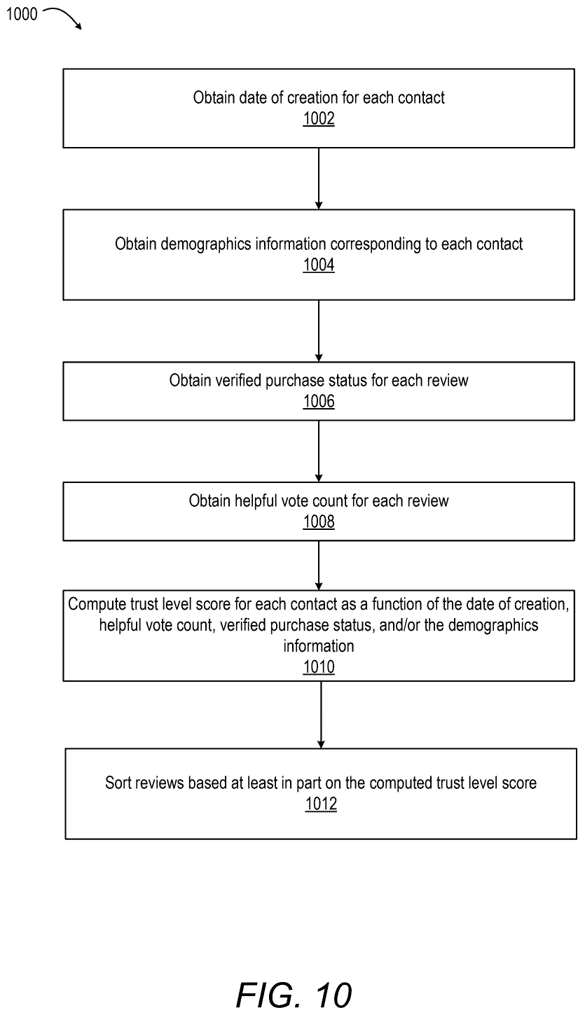

Referring now to the flowcharts presented by FIG. 8, FIG. 9, and FIG. 10, the descriptions of the methods in FIG. 8, FIG. 9, and FIG. 10 are provided with general reference to the specific components and features illustrated within the preceding FIGS. 1-7. Specific components referenced in the methods of FIG. 8, FIG. 9, and FIG. 10 may be identical or similar to components of the same name used in describing preceding FIGS. 1-7. In one or more embodiments, processor 102 (FIG. 1) configures electronic device 100 (FIG. 1) to provide the described functionality of the methods of FIG. 8, FIG. 9, and FIG. 10 by executing program code for one or more modules or applications provided within system memory 120 of electronic device 100, including IQI module 152 (FIG. 1).

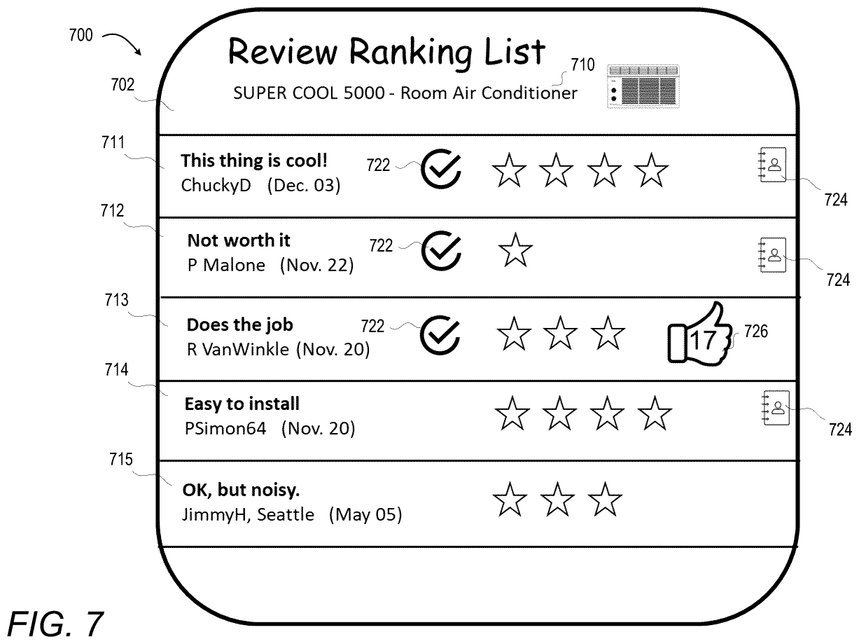

FIG. 7 depicts an exemplary review ranking user interface 700 presenting ranked reviews of an item, according to one or more embodiments. In one or more embodiments, the user interface shown in FIG. 7 may be rendered on a display 702 of a device such as device 100 of FIG. 1. The user interface 700 includes an item summary section 710. The item summary section 710 includes information that identifies an item (product or service), for which the ranked reviews are presented. The ranking shown in FIG. 7 can be based on a computed trust score. In FIG. 7, there are five reviews shown. A highest ranked review is indicated at 711. The next highest ranked review is indicated at 712. The next highest ranked review is indicated at 713. The next highest ranked review is indicated at 714. The lowest ranked review is indicated at 715. In one or more embodiments, a wide variety of criteria can be used for ranking the reviews. One criterion can include if the review originated from a known contact, such as indicated by icon 724, that is present in the review indicated at 711, the review indicated at 712, and the review indicated at 714. Another criterion can include if the review is confirmed from a verified purchaser on an ecommerce platform, as indicated by icon 722, that is present in the review indicated at 711, the review indicated at 712, and the review indicated at 713. Another criterion can include a number of helpful votes (votes by others in the online community that found the review to be helpful), which is indicated by icon 726, which indicates 17 helpful votes corresponding to the review indicated at 713. The lowest ranked review, indicated at 715, is not based on a verified purchase, and does not originate from a known contact. In one or more embodiments, the date of the review may also be used as a criterion for ranking. In one or more embodiments, the recency of a review can contribute to a higher ranking. One or more embodiments may use the various criteria for ranking the reviews. In one or more embodiments, users may establish preferences for ranking the reviews. As an example, one user may opt to prioritize reviews from known contacts, whereas another user may opt to prioritize the number of helpful votes. Note that in the example shown in FIG. 7, the review at 713 is ranked higher than the review at 714, even though the review at 714 is from a known contact, as indicated by icon 724, and the review at 713 is not from a known contact. However, the review at 713 is from a verified purchaser, as indicated by icon 722 and has 17 helpful votes, as indicated by icon 726. Accordingly, the highest ranked reviews may not always be based on known contacts. However, in one or more embodiments, a considerable amount of weight can be given to reviews originating from known contacts, and so reviews from known contacts may be more likely to be presented at a higher ranking than those reviews that do not originate from known contacts. In one or more embodiments, the verified purchase status, helpful votes, date, geographical location of the reviewer, and/or known contact status, can all be used as criteria for computing a trust level score that is used for generating a ranked list of reviews such as depicted in FIG. 7. In one or more embodiments, the trust level score can be color coded, displayed numerically, and/or otherwise indicated on the user interface 700.

FIG. 8 depicts a flowchart of a method for item query initiation, according to one or more embodiments. The method 800 starts at block 802, where prepurchase activity for an item is detected. The prepurchase activity can include, but is not limited to, accessing a product/service webpage, adding a product/service to a virtual shopping cart, searching for a product/service using an online search engine, and so on. The method 800 continues to block 804, where a list of one or more reviews for the item is obtained. In one or more embodiments, the list of one or more reviews, along with corresponding metadata for each review, can be obtained from an online ecommerce site, product review website, social media platform, and/or other sources. In one or more embodiments, protocols including, but not limited to, HTTP (Hypertext Transfer Protocol). RESTful APIs, SOAP (Simple Object Access Protocol), and/or WebSockets may be used for interfacing with online sources to obtain reviews.

The method 800 continues with obtaining a user identifier for each review at block 806. In one or more embodiments, the user identifier may be included as metadata associated with a review. Additional metadata may include a date of the review, a location of the review, a rating of the review, and/or other suitable metadata items. The metadata can include review information that may include a user identifier (username), location, and/or demographic information such as age and/or gender. The metadata may further include details about the product or service being reviewed, including the name, brand, model, and any specific features or variations. The metadata may further include details about the purchase such as the date of purchase, the vendor/merchant where the item was purchased, and the price paid. The metadata may further include a helpful votes metric, which indicates the number of other users who found the review helpful, which can serve as an indicator of the perceived usefulness or credibility of the review. The metadata may further include a verified purchase label indicating whether the reviewer purchased the product or service through the platform, which can add credibility to the review. In one or more embodiments, the helpful votes metric and/or verified purchase label are used in sorting the list of reviews. More, fewer, and/or different metadata fields may be included in some reviews, in one or more embodiments.

The method 800 continues to block 808, where a determination is made, based on the user identifier, if one or more reviews in the list of reviews correspond to a contact in a contact list associated with the electronic device or the user of the electronic device. The determination can be made based on comparing the user identifier and/or other associated metadata with information in a contact database. In one or more embodiments, fuzzy matching techniques may be utilized to identify a contact that is associated with a review. The method 800 continues to block 810, where, the list of reviews is sorted, based at least in part on user identifiers of reviews in the list of reviews that correspond to contacts in the contact list, such as depicted in FIG. 2. One or more embodiments can include: detecting, by a processor of an electronic device, prepurchase activity for an item; obtaining a list of one or more reviews for the item; obtaining a user identifier for each review in the list of one or more reviews; determining, based on the user identifier, if one or more reviews in the list of reviews correspond to a contact in a contact list associated with the electronic device and/or a user; and in response to determining that a user identifier associated with at least one review corresponds to a contact in the contact list, resorting and presenting the list of reviews based at least in part on user identifiers of reviews in the list of reviews that correspond to contacts in the contact list associated with the electronic device or the user/potential purchaser.

FIG. 9 depicts a flowchart of a method 900 for salutation generation for a salutation included as part of an FRQ, according to one or more embodiments. The method 900 starts at block 902, where a communication pattern between an electronic device and a second electronic device is determined. The second electronic device corresponds to a contact that is associated with a review. The communication pattern can include a frequency of how often communication is exchanged. The communication pattern can include a recentness of the previous communication. In one or more embodiments, the communication pattern is obtained, at least in part, based on one or more communication logs for the electronic device. The communication can include telephone calls, app-based voice calls, text messages, emails, app-based text messages, and so on. The method 900 further includes generating a salutation for the item FRQ based on the communication pattern, at block 904. The type of the salutation can include polite/formal, casual/informal, a language for the greeting, and can include an introductory (ice-breaker) phrase when the time of the last communication exceeds a predetermined threshold. In one or more embodiments, the salutation can be recipient specific, and can be based on a determined pattern obtained from previous communications (e.g., text messages, emails, etc.) The salutation can include a casual/informal salutation, such as shown at 320 of FIG. 3. The salutation can include a polite/formal salutation, such as shown at 420 of FIG. 4. The method 800 can further include prepending the salutation to the query at block 906, such as illustrated in FIG. 3, where salutation 320 is prepended to template-based portion 330 in item FRQ 310. The method can further include transmitting the query to the second electronic device at block 908. One or more embodiments can include: determining a communication pattern between the electronic device and a second electronic device associated with the contact; generating a salutation for the query, based on the communication pattern; and transmitting the query to the second electronic device.

FIG. 10 depicts a flowchart of a method 1000 for sorting reviews based on trust level and other factors, according to one or more embodiments. The method 1000 starts at block 1002, where a date of input/creation is obtained for each contact that is associated with a review of the item. The date of input/creation of the contact can be retrieved from the contact database, such as contact database 157 of FIG. 1. The method 1000 continues to block 1004, where demographics information corresponding to each contact is obtained from the contact metadata. In one or more embodiments, the demographics information can include an age and/or an age range, a sex of the contact, a geographic location of the contact, etc. The method 1000 continues with obtaining a verified purchase status for each review at block 1006. In one or more embodiments, the verified purchase review can originate from an ecommerce platform associated with the review. The method 1000 continues with obtaining a helpful vote count for each review at block 1008. The method 1000 continues to block 1010 with computing a trust level score for each contact as a function of the date of creation, helpful vote count, verified purchase status, and/or the demographics information.

One or more embodiments can include: obtaining a date of creation for each contact; obtaining demographics information corresponding to each contact; and computing the trust level score for each contact as a function of the date of creation and the demographics information. In one or more embodiments, an older contact (created earlier) is deemed to have a higher trust level than a newer contact (created more recently than the older contact). The trust level score may also be based on the demographics. As an example, a recommendation for an automobile to purchase may be deemed more credible from a reviewer in the age range of 40-45 years of age than for a reviewer in the age range of 18-23 years of age. Gender can also play a role in the trust level, as some products may be used more by men, or by women. Additionally, geographic location can be a criterion. For example, a review for a snowplow from a user in Canada may have a higher trust level than a review for a snowplow from a user in Florida. In one or more embodiments, a trust level score is computed for each review that is presented in a review section of a user interface, such as review section 213 of user interface 200 of FIG. 2. The method 1000 can include sorting reviews based at least in part on the computed trust level score at block 1012, and presenting the sorted reviews in a review section of a user interface such as user interface 700 of FIG. 7. One or more embodiments can include: determining that a second user identifier associated with at least one review corresponds to a second contact in the contact list; and sorting the reviews based at least in part on a first communication pattern corresponding to the contact and a second communication pattern corresponding to the second contact. For example, a review corresponding to a contact with whom there is frequent communication may be ranked higher than a second review corresponding to a second contact with whom there is infrequent communication. One or more embodiments can include: computing a trust level score for each contact in the contact list; and sorting the reviews based at least in part on the computed trust level score for each of the contacts in the contact list.

Disclosed embodiments can be used when planning to purchase items online, such as goods and services from online retailers, auction sites, and the like. Moreover, disclosed embodiments can be utilized when planning to purchase items in a physical store. The overall methodology is similar, regardless of where the purchase takes place. The items are not limited to items that are typically purchased online, and can also include items that are often purchased at a physical location, such as groceries, appliances, and automobiles. Thus, disclosed embodiments are applicable to both online and in-person shopping experiences.

As can now be appreciated, disclosed embodiments provide techniques for sorting, managing, ranking, and presenting reviews for products. Moreover, disclosed embodiments provide techniques for automating tedious tasks such as composing queries about products, analyzing responses, and the like. Accurate product reviews play a crucial role in helping consumers make informed purchasing decisions by providing insights into product quality, performance, features, and user experience. By considering reviews from reliable sources, a purchaser can increase the likelihood of making a satisfying purchase that meets his/her needs and expectations. Disclosed embodiments identify contacts that have generated a review for an item under consideration for purchase, utilize machine learning techniques to generate product queries to those contacts about the item, analyze responses to those queries, and generate purchase recommendations based on the responses. Thus, disclosed embodiments improve the technical fields of ecommerce and/or product and services review management and analysis.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device, including a display;
a communication system that enables the electronic device to communicatively connect with an online purchasing portal and at least one second electronic device of a known contact;
a memory having stored thereon an item query initiation (IQI) module; and
at least one processor communicatively coupled to the display, the communication system, and the memory, wherein the at least one processor executes program code of the IQI module and configures the electronic device to:
detect prepurchase activity for an item;
obtain a list of one or more reviews for the item;
obtain a user identifier for each review in the list of one or more reviews;
determine, based on the user identifier, if one or more reviews in the list of reviews correspond to a contact in a contact list associated with the electronic device; and
in response to determining that a user identifier associated with at least one review corresponds to a contact in the contact list: sorting the list of reviews based at least in part on user identifiers associated with reviews in the list of reviews that correspond to contacts in the contact list; and presenting the sorted list of reviews on the display.

2. The electronic device of claim 1, wherein the at least one processor further configures the electronic device to generate a query pertaining to the item for presentation to the contact.

3. The electronic device of claim 2, wherein to generate a query pertaining to the item, the at least one processor:
determines a communication pattern between the electronic device and a second electronic device associated with the contact;
generates a salutation for the query, based on the communication pattern; and
transmits, via the communication system, the query to the second electronic device.

4. The electronic device of claim 3, wherein further the at least one processor:
receives a recommendation response from a user of the second electronic device; and
generates a purchase recommendation for the item, based at least in part on the received recommendation response.

5. The electronic device of claim 1, wherein further the at least one processor:
determines that a second user identifier associated with at least one review corresponds to a second contact in the contact list; and
sorts the reviews based at least in part on a first communication pattern corresponding to the contact and a second communication pattern corresponding to the second contact.

6. The electronic device of claim 4, wherein further the at least one processor:
computes a trust level score for each contact in the contact list; and
sorts the reviews based at least in part on the computed trust level score for each of the contacts in the contact list.

7. The electronic device of claim 6, wherein to compute the trust level score for each contact in the contact list, the at least one processor:
obtains a date of creation for each contact;
obtains demographics information corresponding to each contact; and
computes the trust level score for each contact as a function of the date of creation and the demographics information.

8. A method comprising:
detecting, by a processor of an electronic device, prepurchase activity for an item;
obtaining a list of one or more reviews for the item;
obtaining a user identifier for each review in the list of one or more reviews;
determining, based on the user identifier, if one or more reviews in the list of reviews correspond to a contact in a contact list associated with the electronic device; and
in response to determining that a user identifier associated with at least one review corresponds to a contact in the contact list, sorting the list of reviews based at least in part on user identifiers of reviews in the list of reviews that correspond to contacts in the contact list associated with the electronic device.

9. The method of claim 8, further comprising generating a query pertaining to the item for presentation to the contact.

10. The method of claim 9, further comprising:
determining a communication pattern between the electronic device and a second electronic device associated with the contact;
generating a salutation for the query, based on the communication pattern; and
transmitting the query to the second electronic device.

11. The method of claim 10, further comprising:
determining that a second user identifier associated with at least one review corresponds to a second contact in the contact list; and
sorting the reviews based at least in part on a first communication pattern corresponding to the contact and a second communication pattern corresponding to the second contact.

12. The method of claim 8, further comprising:
computing a trust level score for each contact in the contact list; and
sorting the reviews based at least in part on the computed trust level score for each of the contacts in the contact list.

13. The method of claim 12, further comprising:
obtaining a date of creation for each contact;
obtaining demographics information corresponding to each contact; and
computing the trust level score for each contact as a function of the date of creation and the demographics information.

14. The method of claim 9, further comprising:
receiving a recommendation response from a second electronic device; and
generating a purchase recommendation for the item, based on the received recommendation response.

15. A computer program product comprising a non-transitory computer readable medium having program instructions that when executed by a processor of an electronic device comprising a display, configure the electronic device to perform functions comprising:
detecting, by a processor of an electronic device, prepurchase activity for an item;
obtaining a list of one or more reviews for the item;
obtaining a user identifier for each review in the list of one or more reviews;
determining, based on the user identifier, if one or more reviews in the list of reviews correspond to a contact in a contact list associated with the electronic device; and
in response to determining that a user identifier associated with at least one review corresponds to a contact in the contact list, sorting the list of reviews based at least in part on user identifiers of reviews in the list of reviews that correspond to contacts in the contact list associated with the electronic device.

16. The computer program product of claim 15, further comprising program instructions for generating a query pertaining to the item for presentation to the contact.

17. The computer program product of claim 16, further comprising program instructions for:
determining a communication pattern between the electronic device and a second electronic device associated with the contact;
generating a salutation for the query, based on the communication pattern; and
transmitting the query to the second electronic device.

18. The computer program product of claim 17, further comprising program instructions for:
determining that a second user identifier associated with at least one review corresponds to a second contact in the contact list; and
sorting the reviews based at least in part on a first communication pattern corresponding to the contact and a second communication pattern corresponding to the second contact.

19. The computer program product of claim 15, further comprising program instructions for:
computing a trust level score for each contact in the contact list; and
sorting the reviews based at least in part on the computed trust level score for each of the contacts in the contact list.

20. The computer program product of claim 19, further comprising program instructions for:
obtaining a date of creation for each contact;
obtaining demographics information corresponding to each contact; and
computing the trust level score for each contact as a function of the date of creation and the demographics information.
